(19) United States
(12) Patent Application Publication
(10) Pub. No.: US 2006/0193448 A1
(43) Pub. Date: Aug. 31, 2006

(54) Method and apparatus for augmenting voice data on a mobile device call

(76) Inventors: Karen Donoghue, Arlington, MA (US); William C. Barnert, Cambridge, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/293,036

(22) Filed: Dec. 2, 2005

Related U.S. Application Data
(60) Provisional application No. 60/633,287, filed on Dec. 3, 2004.

(51) Int. Cl. H04M 1/64

(52) U.S. Cl. 379/67.1

(57) ABSTRACT

A computer method and system for portable phone devices enable a user to compose and send a data message (e.g., a photo/image) during a voice call. The data message includes any of image data, audio (music) packette, an electronic calendar entry/event, contact information, HTML, text-based data, video data, multimedia and the like. During a voice call session between a user and a recipient, the user using a subject phone device obtains at least one data element. The subject phone device automatically forms and transmits a data message, including the at least one data element, to the recipient of the voice call session. The subject phone device maintains and continues the voice call session with voice data indicative of verbal conversation between the recipient and user. The subject phone device may be a PDA, mobile/cellular phone or other wireless communication and data device.

### RELATED APPLICATION

This application claims the benefit of U.S. Provisional Application No. 60/633,287, filed on Dec. 3, 2004, the entire teachings of which are incorporated herein by reference.

### BACKGROUND OF THE INVENTION

With the advent of portable, wireless telephone devices, various additional features for use on such devices are being developed. One such feature is video sharing. Video sharing allows a party to a cellular/mobile phone call to view a live video or a video clip in real time during a voice call. See Nokia Video Sharing at the Nokia.com website; and 2-way video conferencing at the symbian.com website and mobilemag.com website.

However, there are problems with sharing of data during a phone/voice call as follows. In FIG. 1a at step A, using a mobile phone, Harry 10 calls Karen 12 on her mobile phone/device, and they talk to each other at step B. If Karen 12 wants to send any text or image type data to Harry 10, she hangs up at step C and re-establishes a separate connection between their mobile phones using a messaging application to send the data (step D). Even if she could send the data while on the first phone connection (at steps A, B), she would have to manually compose a message and key in/enter Harry's email address.

### SUMMARY OF THE INVENTION

The present invention is a novel and non-obvious method and system for enabling a user to compose and send a data message (e.g. a photo) during a phone/voice call. “Data message” includes image data, audio (music) data packette, a calendar entry or event, contact information, HTML, text based packette, a video clip, a multimedia segment and the like.

In a preferred embodiment, the invention system and method for augmenting voice data on a phone/voice call includes the computer implemented steps of:
during a voice call session between a user and a recipient, the user using a subject handset, (a) enabling the user to obtain at least one data element using the subject handset, and (b) forming and transmitting a data message to the recipient from the subject handset, the data message including the at least one data element as its contents; and
continuing the voice call session with voice data indicative of verbal conversation between the recipient and user through the subject handset.

The invention step of forming a data message includes automatic addressing of the data message to the recipient based on the voice call session. That is, the data message inherits the original voice call context (recipient name/phone number/corresponding email address as addressee name and target delivery location).

The subject handset is preferably a mobile phone, PDA or similar wireless communication and/or data device. The user obtained data element is any of image data, multimedia data, audio (music) data, text-based data, graphics and video data. The data element may be formed during the voice call session, such as using a camera coupled to (e.g., built into) the subject handset. The data element may also include stored data (image, text, multimedia, audio/music, calendar event, contacts, etc.) of the subject handset. The recipient may be the mobile phone being used by the other party in the call or any other contact method associated with this user in the contact database (e.g., email address, mobile phone, etc.)

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1a is an illustration of the prior art mobile device usage.

FIG. 1b is an illustration of the present invention mobile device use.

FIG. 2a is a block diagram of a hand held, portable electronic device embodying the present invention.

FIGS. 2b and 2c are flow schematics of the embodiments of the present invention.

FIG. 3 is an illustration of a “Call” tab in the user interface during an active voice call of a preferred embodiment.

FIGS. 4a-4b are illustrations of a “Send Picture” tab in the user interface of the preferred embodiment of FIG. 3.

FIG. 5 is an illustration of a “Send Other” tab in the user interface of the preferred embodiment of FIG. 3.

### DETAILED DESCRIPTION OF THE INVENTION

A description of preferred embodiments of the invention follows.

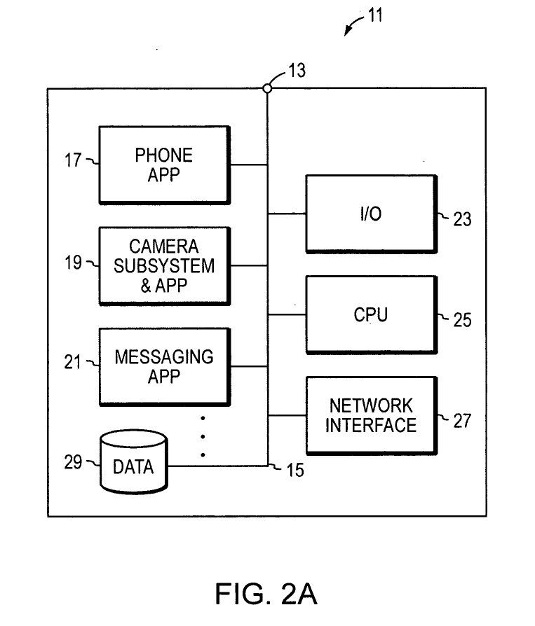

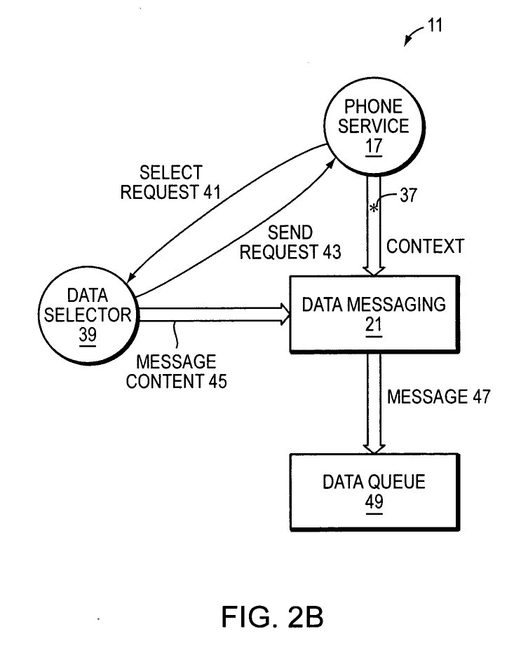

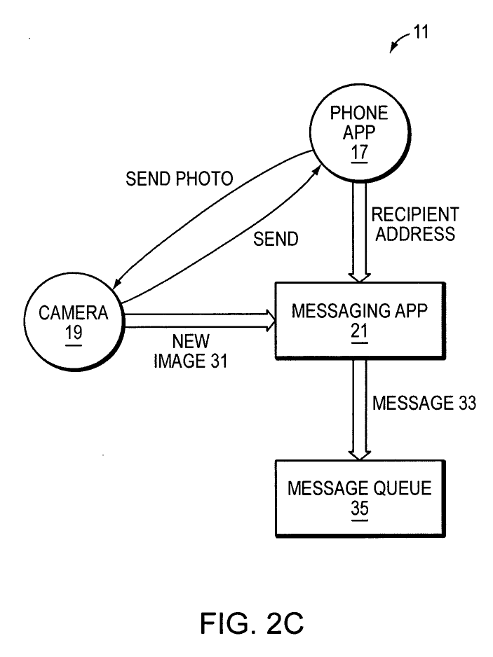

Illustrated in FIG. 2a is a block diagram of a hand held portable digital communication and data device 11. Examples of such a device include mobile/cellular phones, PDA's (personal data assistants), and other electronic devices for carrying digital data representing voice, audio, images, video, text and/or multimedia. An I/O port 13 transmits and receives signals carrying such digital data, for example to initiate a connection and after a connection is established during (throughout) a working session. A main bus 15 carries the digital data between the I/O port 13 and various applications (processor routines and the like) such as phone application 17 and messaging (email) application 21 according to respective protocols (e.g., SMTP, TCP/IP, Bluetooth, etc.). The various applications 17, 19, 21 may have corresponding data 29. Included in data 29 is contact information (e.g., names, mobile and other phone numbers, email addresses, etc.) such as for supporting an address book, calendar data and other data for use with applications 17, 19, 21. Device 11 also includes a camera subsystem 19 further discussed below.

Attached to main bus 15 is I/O interface 23 for coupling various input and output devices (e.g., keypad, scroll wheel, actuators, display, speaker, microphone, etc.) to the device 11. Network interface 27 allows the device 11 to connect/communicate to a network. Central processor unit 25 is also attached to main bus 15 and provides for the execution of computer instructions throughout the applications 17, 19, 21 and supporting operating system.

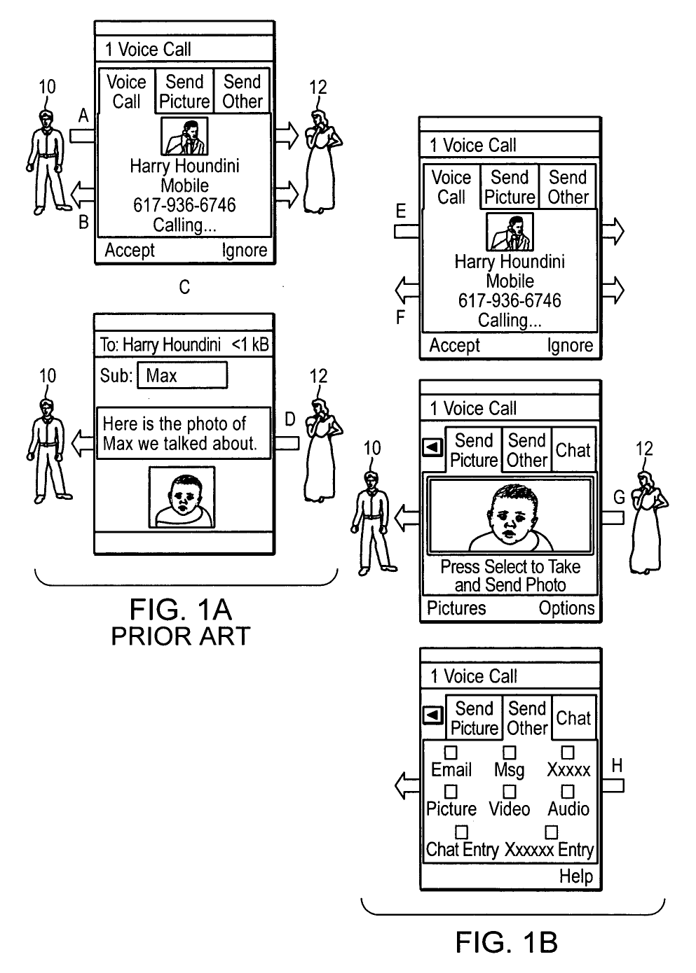

As briefly described above in FIG. 1a, in the prior art the phone application initiates and makes a connection sending and receiving digital voice and audio data across the main bus. Thus the phone application supports a current working session. In order for the user (mobile device) to transmit image or text data, the phone application session (active voice call) must be ended, and a new working session (e.g., email session) supported by the messaging application must be initiated and maintained. That is, after the active voice call to a recipient and supporting phone application session are ended, the messaging application is operated to form (address to the recipient) and send messages including text, image, etc. data across a respective connection. This re-establishing of a connection to the recipient at this time is effectively a redundant and tedious task for the user.

In contrast, the present invention enables a user to transmit images, text, multimedia, etc. data to the phone call recipient during an active voice call/working session supported by the phone application 17. Thus electronic device 11 transmits voice and image data to the call recipient in a same working session (e.g., solely the voice call session) initiated and maintained by the phone application 17 and independent of a separate email session. Further, the name (and corresponding mobile phone number) of voice call recipient is re-used and automatically entered/keyed in as the data message addressee.

To follow the example of FIG. 1 a but using the present invention, as before Harry 10 calls Karen 12 at step E in FIG. 1b using respective mobile phones, and they talk to each other (step F). This time Karen's phone employing the present invention, enables Karen 12, without hanging up (disconnecting the voice call session), to operate the camera subsystem 19 of device 11, take a picture and automatically send it to Harry 10 without her having to manually address it (step G). Karen 12 may also operate the present invention device 11 to locate a stored audio file and when she selects it, the invention system 11 sends it to Harry 10 (step H) within the same one working voice call session (connection).

The present invention takes advantage of the knowledge that Karen 12 might want to send text/image/audio etc. data to Harry's phone, so while still talking, Karen 12 can send data (steps G, H) without having to manually address the data to Harry 10. Even if Harry's phone is not a mobile phone, Karen's phone database 29 contains Harry's mobile phone number or email address. The present invention system 11 addresses the data automatically. (using the stored contact information in database 29) so that Harry 10 can receive the data accordingly. In some embodiments device 11 is not equipped to send voice and text/image/audio file data simultaneously, thus the later data types (text/image/audio files) are automatically addressed and stored (queued) for transmission as soon as the parties 10, 12 hang up the initial voice call/connection.

The foregoing is accomplished as follows.

With respect to FIG. 2c, a user is on an active voice call with phone application 17 supporting the call session. Information identifying the call session (e.g., recipient name and phone number) is stored as data 29 and/or used as an index into the user's address book at 29. Upon user command to use a camera feature, phone application 17 calls camera application 19 to allow the user to operate the electronic device 11 as a camera. The result is the capture of an image (a digital image) 31. The camera application 19 ends by returning control and an indication of the resulting digital image 31 to the phone application 17. The original voice call session remains active. In response, phone application 17 calls the messaging application 21 to “package” the resulting digital image 31 as an outgoing message. The messaging application 21 inherits or automatically assumes the current active voice call recipient as the addressee of the subject outgoing message 33. In particular, messaging application 21 addresses the subject outgoing message 33 using the current active voice call connection number (i.e., recipient's mobile phone number). If the current connection number is not an appropriate device for receiving message 33, then messaging application 21 uses (e.g., defaults to) the recipient's mobile phone number and/or email address as stored in corresponding address book/generally data store 29 (FIG. 2a).

Upon message application 21 output of the subject message 33, system 11 (phone application 17) queues 35 the message 33 for network transmission. All the while, the original voice call session remains active and the user and recipient may carry on a conventional telephone conversation. In some embodiments, transmission of message 33 is immediate. In other embodiments, transmission of message 33 is effected upon completion/cessation of the voice call session.

Generically speaking, the present invention provides the operation of various applications/features 19, 21 within the context 37 of an active phone session of the phone service application 17. In this way, the phone service (application) 17 effectively serves as a shell or container program that executes the other applications (routines, processes) 19, 21 under its request while maintaining the active phone session. With reference to FIG. 2b, at 41 phone service 17 calls or otherwise initiates a data selector 39 to fulfill user command (while conversing on the phone) for a subject data element. This may include enabling user generation of new images or finding/selecting of stored images, video, audio file, music file, multimedia file, calendar or contacts data, etc. 45 to serve as message content. In response (step 43), data selector 39 provides or makes available the requested data file/message content 45.

Next phone service 17 calls/initiates the data messaging member/service 21 to package the subject data file/content 45 into a new message 47. This call to messaging service 21 includes the context 37 (i.e., identification of the active call recipient, name, phone number and/or email address as stored at 29) of the phone service 17 current active phone session. The data messaging service 21 automates the addressing of the newly ordered message (package 47) based on the inherited context 37 and uses the message content 45 produced by data selector 39 as the contents of the new message (package 47). Data messaging service 21 outputs the newly generated message 47 which is queued 49 for transmission. In some embodiments newly generated message 47 is stored in queue 49 until the device network is available for transmission. In other embodiments, network data such as message 47 is transmitted immediately.

Throughout the foregoing, phone service 17 supports the active phone call/session enabling the user and recipient to converse (verbally). As a result, there is no interruption or change in original phone call connection.

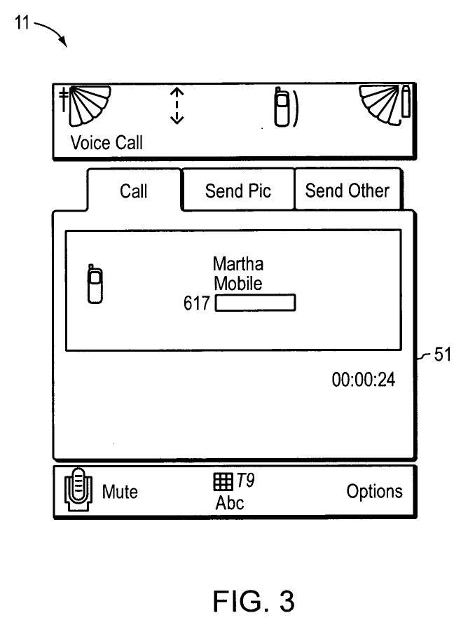

The user interface in a preferred embodiment of device 11 is illustrated in FIGS. 3-5. FIG. 3 shows operation of device 11 as a telephone either in response to receiving an incoming phone call or in response to user command to initiate a phone call. Once a phone call connection is established, the “Call” tab 51 of the user interface indicates the phone number which is party to the active voice call, the running amount of time used on the call, etc. Phone call session data 29 supports this display.

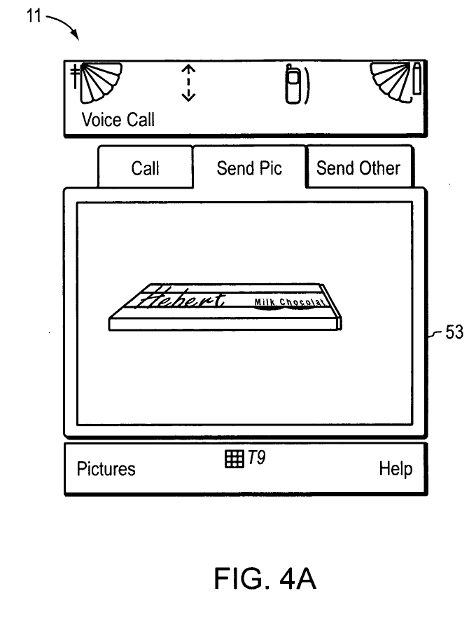

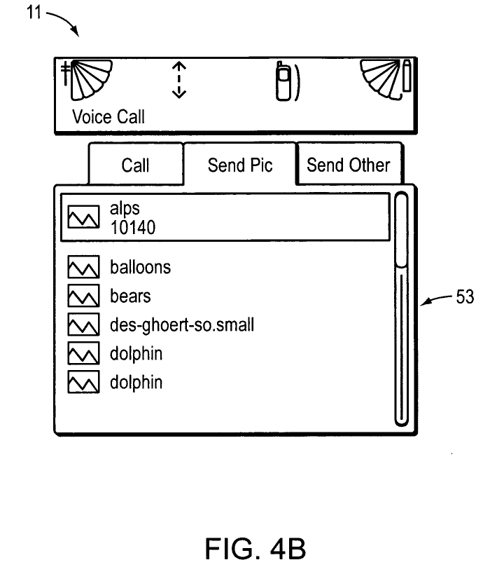

FIG. 4a illustrates the “Send Picture” tab 53 which the user selects, during the active voice call, in order to initiate the camera application/subsystem 19. The image from the camera view finder is shown in the main frame (body) of the “Send Picture” tab 53. Alternatively, through tab 53 the user views and selects from a list of names of stored image files as illustrated in FIG. 4b.

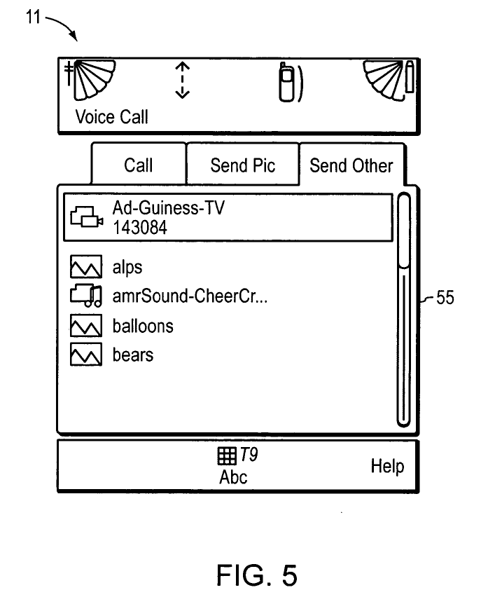

FIG. 5 illustrates a “Send Other” tab 55 which lists for the user names of stored audio files, music files, multimedia files, contact information and other data files in system 11. Here the user interface of device 11 enables user selection of other data to send (transmit) to the call recipient of the active voice call session using the principles of the present invention discussed above.

Tabs 53 and 55 and corresponding supporting software/computer instructions effectively implement the data selector 39 of FIG. 2b. Once the item is selected by the user, the user interface returns to the “Call” tab 51 with prompting indicating that the selected data elements/items have been transmitted (e.g., as a message 33, 47) or are queued for network transmission accordingly. Alternatively, the user interface includes a “send to” portion (screen display) of subject message 33, 47 that automatically defaults to a mobile phone number or email address of the active voice call recipient. The default information is obtained from the phone call session data 29 established at the beginning of the active voice call session (discussed above in FIG. 2c).

While this invention has been particularly shown and described with references to preferred embodiments thereof, it will be understood by those skilled in the art that various changes in form and details may be made therein without departing from the scope of the invention encompassed by the appended claims.

For example, the invention can take the form of software, firmware, hardware and/or a computer program produce accessible from from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

What is claimed is:

1. A method for augmenting voice data on a voice call, comprising the computer implemented steps of:
during a voice call session between a user and a recipient, the user using a subject handset, (a) enabling the user to obtain at least one data element using the subject handset, and (b) forming and transmitting a data message to the recipient from the subject handset, the data message including the at least one data element as its contents; and
continuing the voice call session with voice data indicative of verbal conversation between the recipient and user through the subject handset.

2. A method as claimed in claim 1 wherein said forming includes automatically addressing the data message to the recipient based on the voice call session.

3. A method as claimed in claim 1 wherein the step of enabling includes:
providing the user with a camera coupled to the subject handset;
enabling operation of the camera through the subject handset without interruption of conversation mode operation of the handset.

4. A method as claimed in claim 3 further comprising providing user access to stored data including any of image data, text based data, multimedia, music and calendar event data for selection and transmission to the recipient, without interruption of conversation mode operation of the subject handset.

5. A method as claimed in claim 1 wherein the step of forming a data message includes addressing the data message by automatically defaulting to a mobile phone number or email address of the recipient.

6. A method as claimed in claim 1 wherein the subject handset is a cellular phone, mobile phone or a personal data assistance device.

7. A method as claimed in claim 1 wherein the data element is any of image data, multimedia data, audio data, music data, text-based data and video data.

8. Computer apparatus for augmenting voice data on a voice call, comprising:
a data selector wherein during a voice call session between a user and a recipient, the user using a subject handset, the data selector enables the user to obtain at least one data element using the subject handset;
a messaging member forming and transmitting a data message to the recipient from the subject handset, the data message including the at least one data element as its contents; and
a phone routine maintaining the voice call session in such a manner that exchange of voice data indicative of verbal conversation between the recipient and user may continue through the subject handset during data selector and messaging member operation.

9. Computer apparatus as claimed in claim 8 wherein the messaging member automatically addresses the data message to the recipient based on the voice call session.

10. Computer apparatus as claimed in claim 9 wherein the automatic addressing employs a mobile phone number or email address of the recipient.

11. Computer apparatus as claimed in claim 8 wherein the data selector includes:
a camera coupled to the subject handset in a manner that allows operation of the camera through the subject handset without interruption of conversation mode operation of the handset.

12. Computer apparatus as claimed in claim 11 wherein the data selector further provides user access to stored data including any of image data, text based data, multimedia, music data, calendar event data and audio data for selection and transmission to the recipient, without interruption of conversation mode operation of the handset.

13. Computer apparatus as claimed in claim 8 wherein the subject handset is any of a cellular phone, a mobile phone and a personal data assistance device.

14. Computer apparatus as claimed in claim 8 wherein the data element is any of image data, multimedia data, audio data, music data, text-based data and video data.

15. Computer apparatus in a telephone system having a respective voice call session between a user and a recipient, the user using a subject handset, the computer apparatus comprising:
data selection means for enabling a user to obtain at least one data element using the subject handset;
messaging means for forming and transmitting a data message to the recipient from the subject handset, the data message including the at least one data element; and
phone processor means for continuing the voice call session during the user obtaining the at least one data element and during the messaging means forming the data message.

16. Computer apparatus as claimed in claim 15 wherein the messaging means automatically addresses the data message to the recipient, including employing a mobile phone number or email address of the recipient.

17. Computer apparatus as claimed in claim 15 wherein the data selection means further provides user access to stored data including any of image data, text based data, multimedia, music data, calendar event data and audio data for selection and transmission to the recipient in the data message.

18. Computer apparatus as claimed in claim 15 wherein the subject handset is any of a cellular phone, a mobile phone and a personal data assistance device.

19. Computer apparatus as claimed in claim 15 wherein the data element is any of image data, multimedia data, audio data, music data, text-based data and video data.

20. A computer program product comprising a computer usable medium having a computer readable program, wherein the computer readable program when executed on a computer processor causes the computer processor to:
during a voice call session between a user and a recipient, the user using a subject device, (a) enable the user to obtain at least one data element using the subject device, and (b) address and transmit each obtained data element to the recipient from the subject device;
maintain the voice call session between the recipient and user on the subject device throughout the obtaining and addressing of data elements; and
enable a verbal conversation between the recipient and user to continue throughout the voice call session.
